(19) United States
(12) Patent Application Publication
(10) Pub. No.: US 2008/0059381 A1
(43) Pub. Date: Mar. 6, 2008

(54) Method of providing should-cost negotiations

(76) Inventors: Steven Bruce Reginald, Chillicothe, IL (US); William James Lindholm, Peoria, IL (US); Jeffrey Charles Anderson, Bartonville, IL (US); Jonathan David Roe, Breadsall (GB); Brent Bannister Sugden, Argenta, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/513,107

(22) Filed: Aug. 31, 2006

(51) Int. Cl. G06Q 10/00; G06Q 30/00; H04L 9/00

(52) U.S. Cl. 705/80; 705/1

(57) ABSTRACT

A method for negotiating a purchase price for an assembled good includes providing, by a purchaser, should-cost values associated with the assembled good into a first version of a first data structure, thereby creating a first file. The method additionally includes providing a second version of the first data structure to a seller. The second version of the first data structure has input portions permitting the seller to input seller should-cost values that include a cost rate value indicating a cost rate for performing an operation associated with the assembled good, and one or more time values indicating a time required for performing the operation. The method further includes receiving a second file having seller should-cost values provided into the second version of the first data structure by the seller. A forum is provided for negotiating a selling price for the assembled good based on at least the second file.

### TECHNICAL FIELD

The present disclosure relates generally to negotiation mechanisms, and more particularly to methods and systems for providing should-cost negotiations between sellers and purchasers of an assembled good.

### BACKGROUND

Companies typically use should-cost information to determine a selling price for assembled goods. “Should-cost” information generally refers to information that indicates what an item should cost to a potential purchaser or to a manufacturer or seller. For example, should-cost information for an assembled good may include information indicating estimated costs for material and/or parts of the assembled good, information indicating estimated costs of the processes for assembling the parts into the assembled good, information indicating estimated costs of processes to alter any parts used to assemble the good, etc. Often, should-cost information is used individually by a purchaser of an assembled good or a seller of an assembled good to determine, for example, a price the purchaser should offer to pay for the good, or a price at which the seller should offer to sell the good.

In some cases, should-cost information is used to negotiate the price for an assembled good. Software files, such as spreadsheets, have been developed that permit purchasers and sellers to enter data related to should-cost information in order to arrive at a should-cost price estimate for the assembled good. One example of such a spreadsheet is the “Should Cost Worksheet V2.51,” implemented Jun. 9, 2005, and used by Caterpillar Inc.® (hereinafter “V2.51”). This worksheet is used to negotiate prices for goods with suppliers. The worksheet may be loaded by a purchaser with should-cost data from a database, and may be used to calculate a should-cost price for an assembled good. In addition, a blank worksheet may be given to suppliers, who may manually (using software such as Microsoft Excel®) fill in portions of the worksheet to estimate their should-cost price for parts, materials, and certain processes used to manufacture the assembled good. The supplier and purchaser may then negotiate a sale price based on the information stored in their respective should-cost spreadsheets.

While existing should-cost mechanisms are useful in negotiation settings, these mechanisms could benefit from improvements that provide for more accurate and reliable estimates of should-cost values. For instance, although V2.51 permits a user to adjust certain should-cost information, it does not permit a seller to adjust certain information that affects the overall should-cost price. For example, V2.51 requires both the purchaser and the seller to select from the worksheet predetermined, un-adjustable cost rate values for individual manufacturing processes. This may cause sellers to artificially inflate manufacturing process time entries into the spreadsheet in order to achieve a target overall should-cost price, leading to inaccurate estimates that cause inconvenient disparities in negotiated prices and manufacturing schedules. Furthermore, V2.51 limits purchasers and sellers to specific predetermined manufacturing processes, thereby preventing them from accurately estimating should-cost prices for assembled goods that require new, potentially unforeseen manufacturing processes. Thus, V2.51 lacks the flexibility that would permit purchasers and sellers to give a more accurate should-cost estimates during negotiations.

V2.51 further fails to provide a comprehensive graphical display of should-cost information, thereby causing purchasers and sellers to resort to undesirable mathematical comparisons for large numbers of categories. This results in purchasers and sellers analyzing should-cost information and to negotiate inefficiently. V2.51 additionally fails to display information reflecting human inefficiencies associated with manufacturing, such as personal fatigue and delay. Consequently, conventional should-cost mechanisms stand to be improved with a more efficient, reliable, and accurate should-cost model.

The disclosed embodiments are directed to overcoming one or more of the problems set forth above.

### SUMMARY OF THE INVENTION

In a first embodiment, a method is provided for negotiating a purchase price for an assembled good. The method includes providing, by a purchaser, should-cost values associated with the assembled good into a first version of a first data structure, thereby creating a first file. The method further includes providing a second version of the first data structure to a seller of the assembled good. The second version of the first data structure includes input portions that permit the seller to input seller should-cost values that include at least a cost rate value indicating a cost rate for performing an operation associated with the assembled good, and one or more time values indicating a time required for performing the operation on one or more parts of the assembled good. The method further includes receiving a second file from the seller, the second file including seller should-cost values provided into the second version of the first data structure by the seller. A forum is provided for negotiating a selling price for the assembled good between the seller and purchaser based on at least the second file.

In a second embodiment, a method is provided for negotiating a sale price for an assembled good. The method includes receiving a data structure by a seller of an assembled good. The data structure file has entry areas that permit the seller to enter should-cost data. The method further includes creating a should-cost file by the seller by entering the should-cost data, by the seller, into the data structure. The should-cost data includes a part identifier of one or more parts used to manufacture the assembled good, one or more operation names for one or more operations performed on the one or more parts, one or more operation time values indicating a time required for performing the one or more operations on the one or more parts, and a cost rate value indicating a cost rate for performing each of the one or more operations. The method additionally includes using the should-cost file to negotiate a sale price for the assembled good between the seller and a purchaser.

In a third embodiment, a computer program product stored on a computer-readable medium is provided. The computer program product includes instructions that, when executed by a processor, automatically load into a computer-readable file should-cost information including a part identifier of one or more parts used to manufacture an assembled good, one or more operation names for one or more operations performed on the one or more parts, one or more operation time values indicating a time required for performing the one or more operations on the one or more parts, and a cost rate value indicating a cost rate for each of the one or more operations. The computer program product further includes instructions that, when executed by a processor, automatically clear data from a should-cost file. The computer program product additionally includes instructions that, when executed by a processor, permit a user to manually enter should-cost values that include at least a cost rate value indicating a cost rate for performing an operation associated with the good and one or more time values indicating a time required for performing the operation on one or more parts. Furthermore, the computer program product includes instructions that, when executed by a processor, provide the should-cost file to a seller or purchaser of the assembled good for negotiating a sale price for the assembled good.

### BRIEF DESCRIPTION OF THE DRAWINGS

FIG. 1 is a is a block diagram illustrating an exemplary system consistent with certain disclosed embodiments;

FIG. 2 is a block diagram of an exemplary purchaser computer system consistent with certain disclosed embodiments;

FIG. 3a is a diagram of a first portion of an exemplary populated data file consistent with certain disclosed embodiments;

FIG. 3b is a diagram of a second portion of an exemplary populated data file consistent with certain disclosed embodiments;

FIG. 4a is a diagram of a first portion of an exemplary blank data file consistent with certain disclosed embodiments;

FIG. 4b is a diagram of a second portion of an exemplary blank data file consistent with certain disclosed embodiments;

FIG. 5 is a diagram of an exemplary bar chart reflecting operation costs consistent with certain disclosed embodiments; and

FIG. 6 is a flow chart illustrating an exemplary method consistent with certain disclosed embodiments.

### DETAILED DESCRIPTION

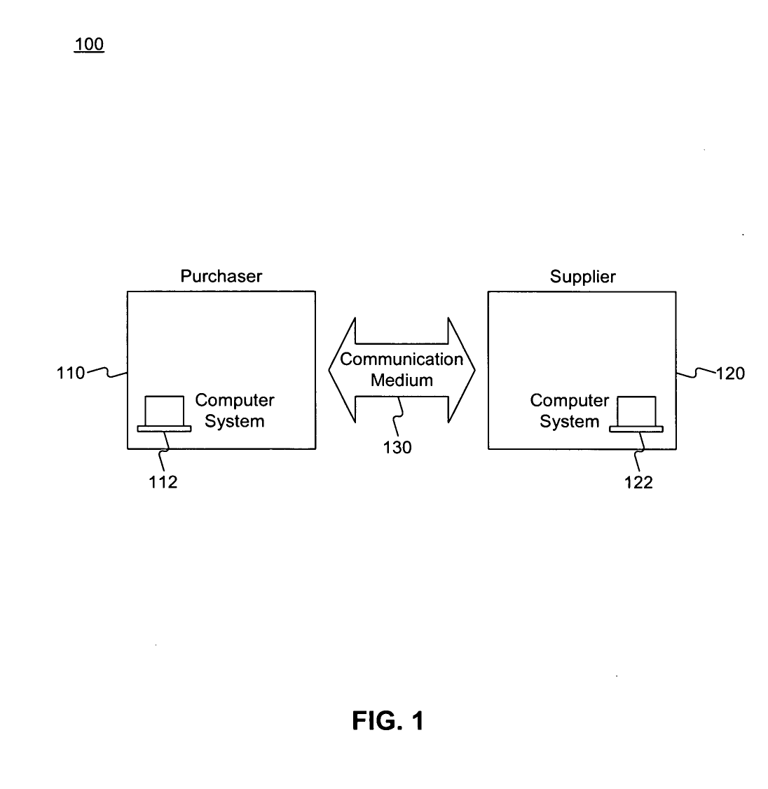

FIG. 1 depicts an exemplary system 100 consistent with certain disclosed embodiments. System 100 includes purchaser 110 and associated purchaser computer system 112, supplier 120 and associated supplier computer system 122, and communication medium 130.

Purchaser 110 may be a company, individual, governmental agency, corporation, non-profit organization, or other entity that purchases assembled goods from suppliers. The term “assembled good” refers to any item that is formed through an assembly process (e.g., created from one or more parts, altered into a new form, etc.) and that may be sold to a purchaser. For example, in one embodiment, purchaser may be a machine manufacturer who purchases machine parts from suppliers. In one embodiment, the machine parts are assembled goods (e.g., goods made by combining machine part components) manufactured by a supplier.

Purchaser computer system 112 may be a personal computer (PC), workstation, laptop computer, personal digital assistant (PDA) or other hand-held device, or any other data processing system capable of carrying out one or more of the disclosed embodiments. In one embodiment, purchaser computer system 112 may be a combination of PCs, workstations, laptop computers, PDAs, and the like, connected by a communication network (e.g., the Internet). For example, in one embodiment, computer system 112 is a PC connected via a network to a central server that stores part information in a database. The PC may additionally be connected to the Internet or another network. Although described as separate elements, a “purchaser,” as used herein, may refer to a purchaser computer system or an individual, company, agency, corporation, organization, etc.

Supplier 120 may be a company, individual, governmental agency, corporation, non-profit organization, or other entity that sells goods to purchasers. For example, in one embodiment, supplier 120 is a machine part manufacturer who sells machine parts to a machine manufacturer. The term “supplier” may also be referred to as “seller.” Supplier computer system 122 may be a personal computer (PC), workstation, laptop computer, PDA or other hand-held device, or any other data processing system capable of carrying out one or more of the disclosed embodiments. In one embodiment, supplier computer system 122 may be a combination of PCs, workstations, laptop computers, PDAs, and the like, connected by a communication network (e.g., the Internet). For example, in one embodiment, supplier computer system 122 is a PC connected via a network to a central server that stores part information in a database. The PC may additionally be connected to the Internet or another network. Although described as separate elements, a “supplier” or “seller,” as used herein, may refer to a supplier or seller computer system, or to an individual, company, agency, corporation, organization, etc.

Communication medium 130 is any communication medium or combination of communication media that provides a forum for purchaser 110 and supplier 120 to communicate and negotiate with each other. Communication medium 130 may be a telephone network, postal mail network, computer network, fax network, wireless communication network, combination of one or more of these networks, or other medium that permits the exchange of information by paper, electronic, audio, or other means. In one embodiment, communication medium 130 may be a physical location (e.g., meeting room) where purchaser 110 and supplier 120 meet and exchange information. In other embodiments, communication medium 130 is a data communication network for exchanging data between remote systems. As described further below, system 100 allows purchasers and suppliers to negotiate the sale of a good by permitting both a purchaser and a supplier to determine a “should-cost” purchase price for the good and its parts and by permitting the purchaser and supplier to exchange their should-cost prices (e.g., by exchanging data in the form of a spreadsheet or table). Thus, communication medium 130 may be any medium that permits such communication.

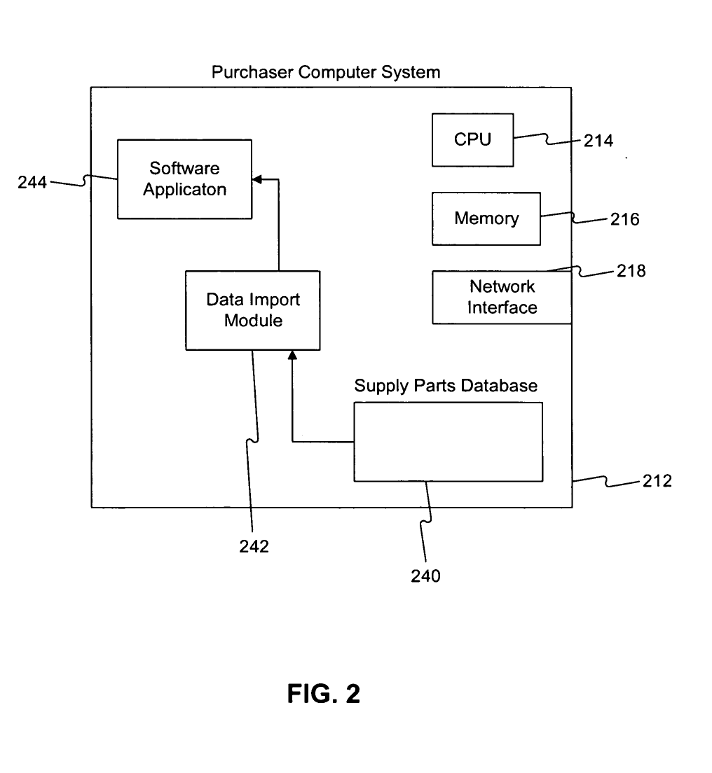

FIG. 2 depicts an exemplary computer system 212 associated with a purchaser, consistent with out one or more disclosed embodiments. As described above, purchaser computer system 212 may be one or more PCs, laptop computers, PDAs, workstations, etc., either standing alone or combined as part of a communication network. In one embodiment, computer system 212 includes hardware components, such as central processing unit (CPU) 214, memory storage 216, network interface 218, and any other known components (e.g., CD/DVD ROM drive, I/O ports, power source, display screen, keyboard, mouse, etc.) typically used in data processing devices such as PCs, PDAs, laptops, etc. Computer system 212 additionally includes one or more software or firmware components (e.g., applications, macros, computer code such as Visual Basic™, C++, etc.) stored on a computer readable medium (e.g., hard drive, ROM memory, RAM memory, flash memory, etc.) and used to operate computer system 212. In one embodiment, computer system 212 uses these hardware, software, and/or firmware components to implement supply parts database 240, data import module 242, and software application 244. In certain embodiments, supplier computer system 122 may be configured similarly to purchaser computer system 212.

Supply parts database 240 is a database or other storage device that stores information relating to parts used by supplier 120 to manufacture assembled goods. In one embodiment, for each part, supply parts database 240 stores information that describes the part, describes one or more processes necessary to alter the part for use in one or more assembled goods, and describes other characteristics related to the part. For example, in one embodiment, the information includes a part identifier, such as a name (e.g., valve, flange, bolt, washer, hose, seal, etc.), part number, part material(s) (e.g., steel, rubber, plastic, etc.), part weight (in lbs. or kgs.), part cost, part operations necessary for each part when including the part in the assembled good (e.g., sawing, machine-cutting, laser cutting, welding, painting packing and shipping, inspection, etc.), costs and/or cost rates of those operations, number of parts necessary for each assembled good, taxes or additional fees associated with the part, other miscellaneous costs, etc. In one embodiment, supply parts database 240 may be stored, for example, in a database accessible by a software application such as Costimator™, offered by MTI Systems Inc. Database 240 may be stored locally on purchaser computer system 212 (e.g., stored on a PC if computer system 212 is a PC), may be stored remotely (e.g., stored on a remote server if computer system 212 is a PC), or may be stored in a distributed manner (e.g., stored on multiple computers, such as, e.g., a PC and a remote server).

In one embodiment, one or more sets of data stored in parts database 240 may be selected, extracted, and stored as files. For example, using Costimator or a similar software application, a user may make a selection instructing the software application to extract all data related to manufacturing a particular assembled good (e.g., a fuel tank, transmission, drive train, etc.). In response to the selection, the software application may create a text file (e.g., .txt, .csv), a spreadsheet file (e.g., .xls), or other type of computer-usable data file that stores the extracted data. The file is configured to be accessed by data import module 242. In another embodiment, one or more sets of data stored in parts database 240 may be additionally or alternatively accessed directly from parts database 240 by data import module 242.

Data sets stored as files or stored in parts database 240 may then be accessed by data import module 242 to populate a file (e.g., spreadsheet or other type of displayable worksheet file) to be displayed by software application 244. Data import module 242 includes software code that instructs a processor, such as CPU 214, to import data from a stored data file or from supply parts database 240 to software application 244. Data import module 242 may be written using macros or other programming tools, and may be written in any suitable programming language, such as Visual Basic, Java™, C++, etc.

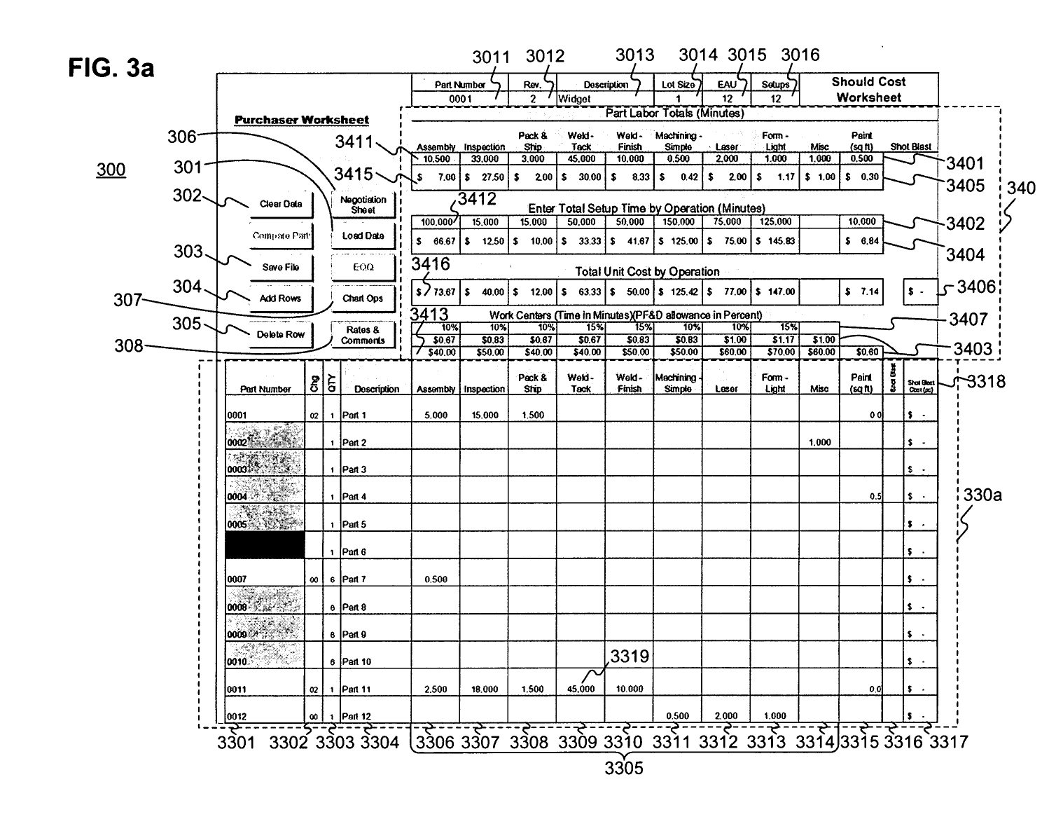

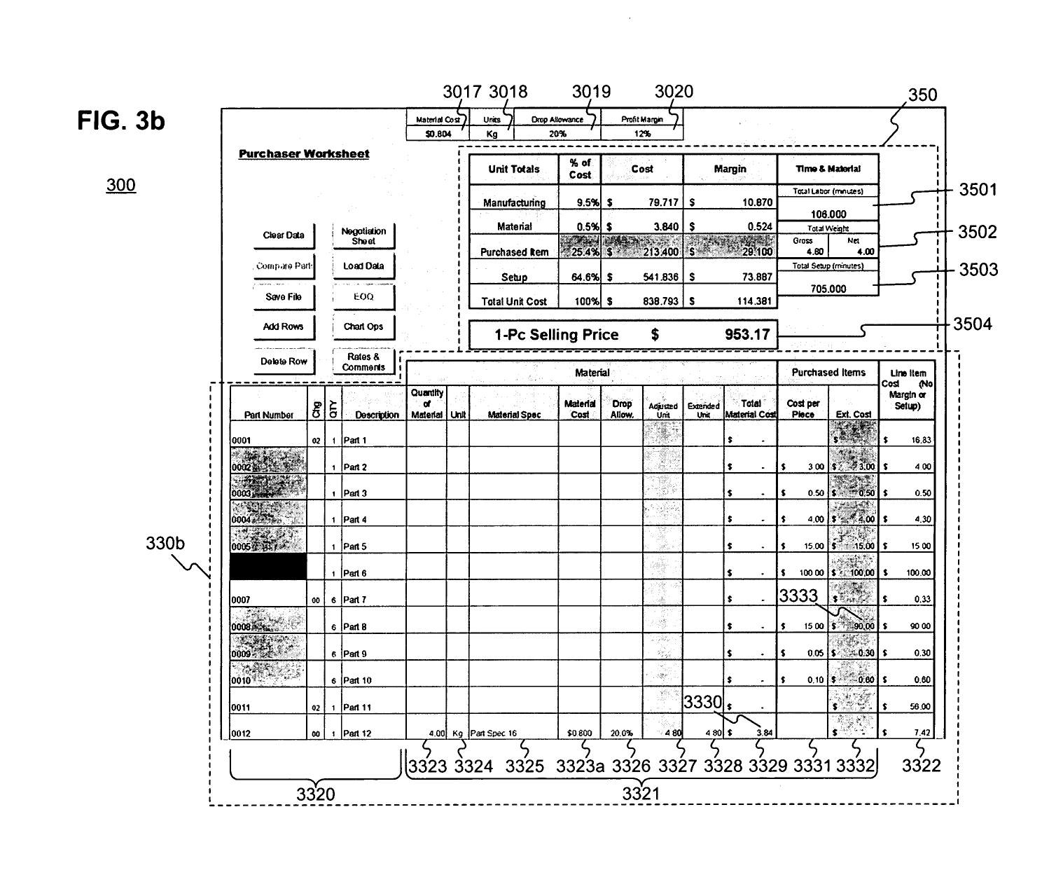

In one embodiment, software application 244 is a spreadsheet application such as Microsoft Excel® or a similar application. As such, in one embodiment, a data file may be imported into software application 244 in a structured manner to form a tabular spreadsheet including associated buttons, as depicted in FIGS. 3a and 3b.

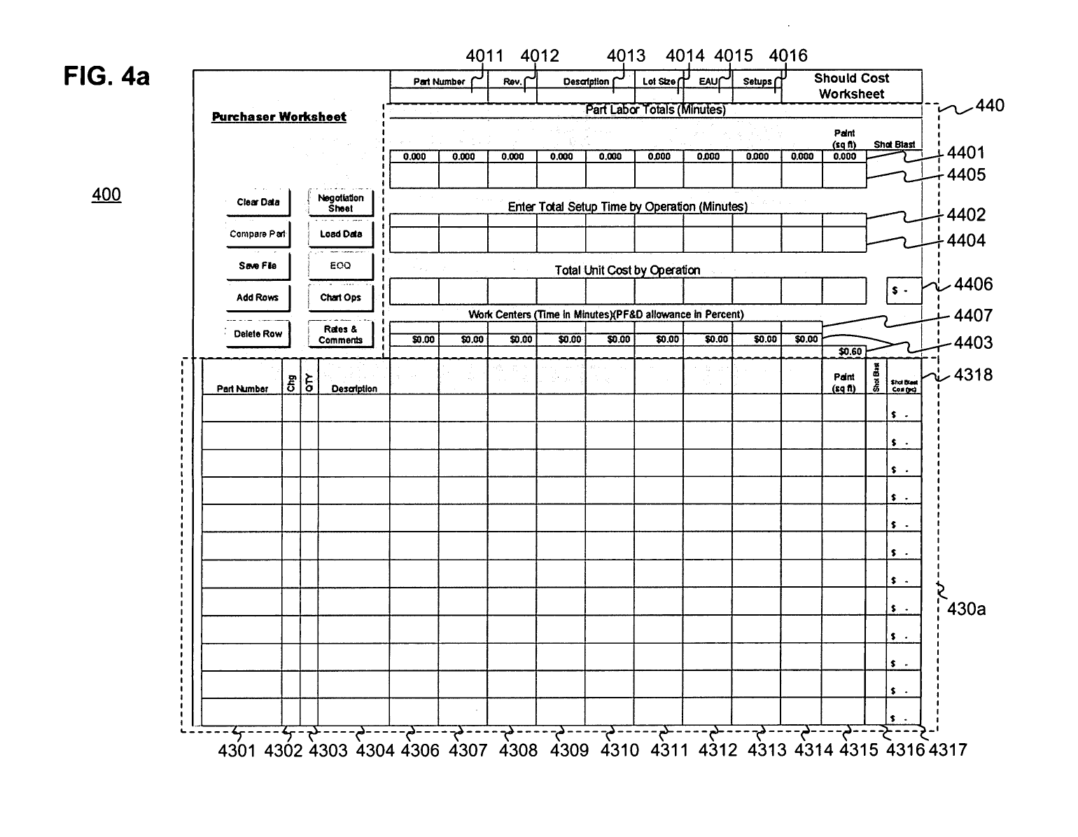

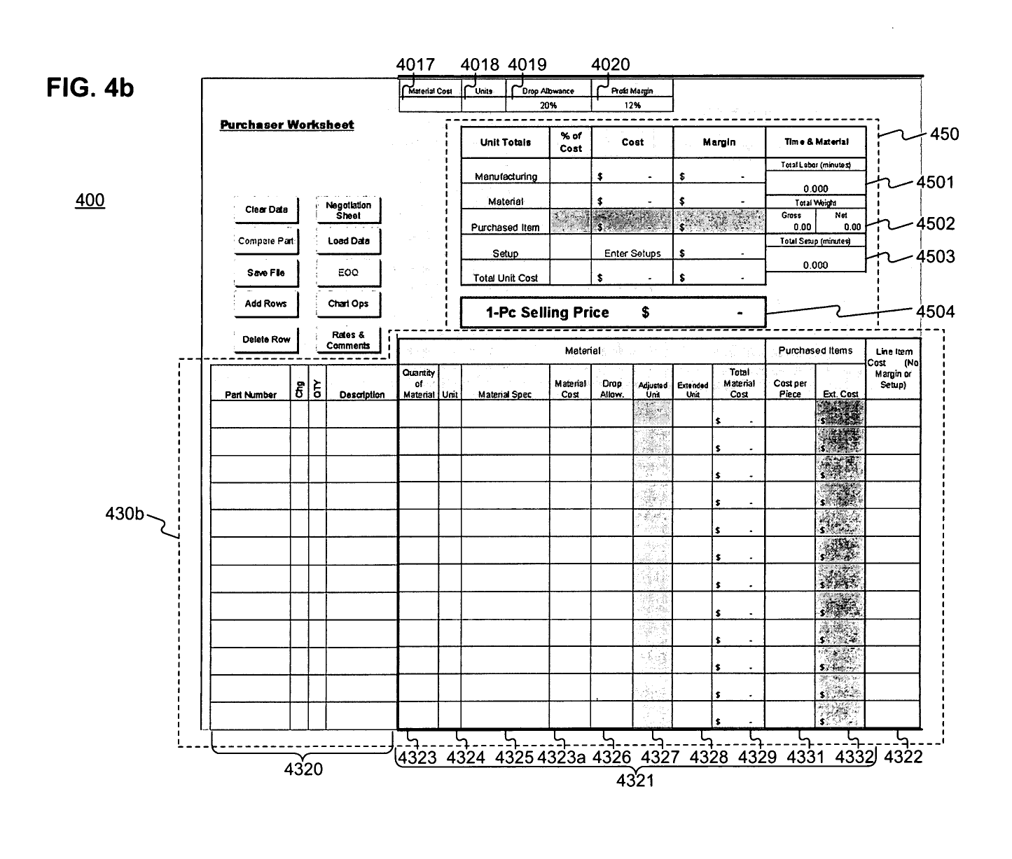

FIGS. 3a, 3b, 4a, and 4b are exemplary embodiments of should-cost negotiation spreadsheets 300 and 400 used to negotiate purchase prices of assembled goods. Although FIGS. 3a and 3b appear on two separate sheets, in one embodiment, they are combined on a single sheet or a single screen to allow a user to view and/or enter all of the displayed information on a single sheet. Similarly, in one embodiment, FIGS. 4a and 4b are combined on a single sheet or screen to allow a user to view and/or enter a set of information on a single sheet. Thus, for example, the lower portion of both FIGS. 3a and 3b displaying rows related to different part numbers (e.g., 0001, 0002, etc.) may be combined into a single table, having a set number of rows (e.g., 13 rows in FIGS. 3a and 3b) and a set number of columns (e.g., 27 columns in FIGS. 3a and 3b). In one embodiment, the upper portions of FIGS. 3a and 3b are then displayed above the combined lower portion. The spreadsheet shown in FIGS. 4a and 4b may be combined in a similar manner.

FIGS. 4a and 4b show a blank negotiation sheet before being populated, while FIGS. 3a and 3b show a negotiation spreadsheet 300 after being populated with should-cost data. In one embodiment, as described further below, a purchaser begins with a blank spreadsheet, such as shown in FIGS. 4a and 4b, as negotiation spreadsheet 400. The purchaser then uses data import module 242 to load data into the blank spreadsheet to create populated negotiation spreadsheet 300, and then sends (via postal mail, e-mail, etc.) a blank version of spreadsheet 300, as shown in FIGS. 4a and 4b as negotiation spreadsheet 400, to the supplier. In one embodiment, the blank version sent to supplier may have certain rows, columns, and/or individual cells locked so that the supplier cannot change some data values or predetermined formulas, such as functions that calculate total should-cost values. The supplier then manually may enter data into one or more data entry locations (e.g., cells on an Excel® spreadsheet) to create a populated version of the supplier negotiation spreadsheet. In one embodiment, spreadsheets 300 and 400 visually distinguish locked cells from unlocked cells based on color or shading (e.g., white cells are unlocked, and shaded cells are locked), although other types of indicators may be implemented. In this embodiment, color-coding or shading is only used as visual aid, and does not necessarily indicate that a certain cell is locked or unlocked.

In one embodiment, spreadsheet 300 begins as a blank spreadsheet (i.e., as shown in FIGS. 4a and 4b as spreadsheet 400) having certain data locations (e.g., cells) filled with text and/or formulas and other data locations (e.g., cells) empty. In one embodiment, spreadsheet 300 may include active buttons that perform some function upon selection. For example, upon a user clicking on the “Load Data” button 301, a selection area may be displayed (e.g., a folder, menu, text entry box, etc.) that permits the user to select a set of information associated with an assembled good to load and display on the spreadsheet. In one embodiment, the user may select from a folder or other storage area that stores one or more data files of information extracted from supply parts database 240. In another embodiment, the user may selectively load data directly from supply parts database 240 into the spreadsheet. After the user selects the data to load, the blank spreadsheet is automatically populated with data, such as the data shown in FIGS. 3a and 3b.

The data loaded into spreadsheet 300 includes information associated with a selected assembled good. The information includes parts used to manufacture the assembled good, material-specific information related to the parts, processes necessary to manufacture the assembled good, fee rates for the processes, and additional information. In one embodiment, the information is derived from a bill of materials associated with the assembled good. For example, in the embodiment shown in FIGS. 3a and 3b, a set of data associated with a selected assembled good named “Part Number 0001” is loaded into the spreadsheet.

The top two rows of spreadsheet 300 include general information for the assembled good. For example, part number cell 3011 includes the part number of the selected assembled good (e.g., “0001”). The part number may be assigned by the purchaser, the supplier, another party, etc. Revision cell 3012 includes an engineering change level number for the assembled good (e.g., “2”). Description cell 3013 includes a description of the assembled good (e.g., “Widget”). Lot size cell 3014 includes the number of assembled goods in a lot (e.g., 1). Typically, goods are sold in lots, where a lot size can be set to include any desired number of goods. Thus, certain cost totals (e.g., setup cost, as described below) are divided by the lot size number to determine the should-cost per good. Estimated annual usage cell 3015 (e.g., “EAU”) includes the estimated annual number of assembled goods used by the purchaser (e.g., 12). Setups cell 3016 includes the number of assembly setups needed to produce the estimated annual usage quantity (e.g., 12). Each assembly setup increases the amount of time necessary to manufacture the assembled goods.

Material cost cell 3017 and units cell 3018 include a material cost per pound or kilogram of material. The value in cell 3017 (e.g., $0.804) represents an average material cost per kilogram for all combined materials needed to manufacture the assembled good. Drop allowance cell 3019 includes information reflecting a percent increase in the overall assembled good material weight to account for the original weight of the material before processing (e.g., including plate or sheet skeletal weight, etc.). Profit margin cell 3020 includes an expected or desired profit margin for the assembled good.

The lower portion of spreadsheet 300, including portion 330a (FIG. 3a) and 330b (FIG. 3b) includes a table having rows of part numbers. For each part number, portions 330a and 330b include: columns for storing information related to processes (i.e. “operations”) necessary to manufacture the assembled good (shown in 330a); columns for storing information related to part material (shown in 330b); and columns for displaying total costs (shown in 330b). The number of rows in portion 330a and 330b varies depending on the number of parts needed to manufacture the assembled good (e.g., the number of parts imported into the spreadsheet). Similarly, the number of columns in portion 330a, and the particular processes included in those columns, also varies depending on the number of processes necessary to manufacture the assembled good (e.g., the number of different processes imported into the spreadsheet).

Portion 330a of FIG. 3a includes a number of exemplary columns according to one embodiment in which data related to a “widget” is imported into spreadsheet 300. For example, part number column 3301 includes data reflecting a part number for each part used in an assembled good (e.g., “0002,” “0003,” etc., used in assembled good 0001). Change column 3302 includes data reflecting the engineering change level of the part (e.g. “00,” “02,” etc.). Quantity column 3303 includes data reflecting the number of parts used to manufacture the assembled good (e.g., six “part 7” parts, one “part 11” part, etc., used to manufacture assembled good 0001). Description column 3304 includes data reflecting a description of each listed part.

Process columns 3305 each include a time amount reflecting the time (in minutes) required for each process used in manufacturing an assembled good. For example, in one embodiment, process columns 3305 include: assembly column 3306 reflecting the time necessary to assemble each part listed in part number column 3301; inspection column 3307 reflecting the time necessary to inspect each part listed in part number column 3301; pack & ship column 3308 reflecting the time necessary to pack and ship each part listed in part number column 3301; weld-tack column 3309 reflecting the time necessary to tack weld each part listed in part number column 3301; weld-finish column 3310 reflecting the time necessary to finish welding each part listed in part number column 3301; machining-simple column 3311 reflecting the time necessary to perform simple machining operations on each part listed in part number column 3301; laser column 3312 reflecting the time necessary to perform laser cutting on each part listed in part number column 3301; form-light column 3313 reflecting the time necessary to light-form each part listed in part number column 3301; and miscellaneous column 3314 reflecting additional time necessary for miscellaneous processes. Paint per square foot column 3315 includes data reflecting an area of square feet to be painted. Shot blast column 3316 includes an indicator reflecting whether shot blasting is necessary for the part (e.g., “yes” could be indicated by a “y,” a “yes,” a checkmark, etc.; “no” could be indicated by a “n,” a “no,” a non-entry, etc.). Shot blast cost column 3317 indicates a cost for shot blasting each part.

The columns included in portion 330a are exemplary only, and depend on the information imported into the table and/or information entered into the table by a user. For example, process columns 3305 may include additional blank columns (not shown) that permit a user to enter additional processes to the spreadsheet. Alternatively, process columns 3305 may include fewer columns than those shown (e.g., if one or more of the depicted processes is not necessary to manufacture a particular assembled good). In one embodiment, additional blank columns (not shown) are included in columns 3305. Each blank column may be manually altered to include both a process name (e.g., in row 3318) and time amounts (e.g., in the remaining rows for each part). In one embodiment, when a user selects a blank cell in row 3318 (e.g., clicks with a mouse or other pointing device), a drop down list appears, which lists a number of possible processes from which the user can select. Alternatively, or additionally, the user may type in a process into a blank cell in row 3318. Furthermore, although certain data values are automatically placed into columns 3305, a user can alter those data values if the user desires. For example, if the user believes that the time of 45 minutes for tack welding of part 0011 is incorrect, the user can manually adjust the value for that process (e.g., shown in cell 3319) by entering a different value.

Portion 330b of FIG. 3b includes a number of exemplary columns related to the same “widget” discussed in connection with FIG. 3a. Thus, the part number, chg, quantity, and descriptions columns 3320 of FIG. 3b correspond to respective columns 3301-3304 of FIG. 3a. Portion 330b additionally includes columns 3321, which include information relating to material and purchased items associated with each part, and further includes column 3322, which includes line item costs for each part.

For example, columns 3321 may include: quantity of material column 3323 and unit of weight column 3324, which include data reflecting the weight of the material used in the part; material spec column 3325, which includes additional specification information about the part material; material cost column 3323a, which includes data reflecting a cost per pound or kilogram for the material for each part listed in part number column 3301; drop allowance column 3326, which includes data reflecting a percent increase in the part weight to account for the original weight of the material before processing (e.g., including plate or sheet skeletal weight, etc.); adjusted unit column 3327, which includes data reflecting the material quantity adjusted for the drop allowance (e.g., taking part 0012 as an example, 120% of the value in quantity of material column 3323); extended unit column 3328, which includes data reflecting the adjusted unit value multiplied by the quantity of parts value in quantity column 3303; total material cost column 3329, which includes data reflecting the extended unit value multiplied by the material cost (e.g., $3.84, as shown in cell 3330); cost per piece column 3331, which includes data reflecting costs of parts or services that are purchased (e.g., from another supplier, etc.) to complete the associated part number (e.g., nuts, washers, bolts, heat treating, plating, special testing, etc.); and extended cost column 3332, which includes data reflecting the cost per piece multiplied by the quantity of parts value in quantity column 3303 (e.g., $90.00, as shown in cell 3333).

Portion 330b further includes line item cost column 3322. The line item cost for each part, includes the cost of material associated with the part added to the cost for processing the part (excluding any setup time costs). Additional columns may be added to portion 330b of spreadsheet 300 including columns related to additional assembled good-related information.

Referring to FIG. 3a, the processing rates, processing costs, setup costs, and total costs associated with each process are displayed in portion 340. Portion 340 includes a number of rows for each process included in portion 330a. For instance, process labor time row 3401 includes, for each process, data reflecting the total accumulated time necessary to run the process in order to make one assembled good. For example, as shown in spreadsheet 300, cell 3411 includes the value “10.500,” which reflects the number of total minutes necessary for the “assembly” operation when manufacturing one assembled “0001” good (e.g., the sum of 3 minutes for assembling six “Part 0007s,” 2.5 minutes for assembling one “Part 0011,” and 5 minutes for assembling the one “Part 0001”).

Setup time row 3402 includes data reflecting total setup time necessary for each process. Each process (e.g., assembly, inspection, pack & ship, etc.) has an associated setup time, which may include, for example, time necessary to set up the equipment used for the process (e.g., warming up a welding machine, calibrating assembly equipment, etc.). For instance, as shown in spreadsheet 300, cell 3412 indicates that assembly operations will require 100 minutes of overall setup time. The setup time value for each process may be imported from database 240 or from stored data files using import module 242. Alternatively, or additionally, the setup time values may be manually entered or altered by a user.

Process rate row 3403 includes data reflecting operation rates (e.g., dollars per hour, dollars per minute, etc.) for each process. For example, cell 3413 includes data reflecting a rate of $40.00 per hour for the “assembly” process. Each process includes an associated rate used to calculate the overall should-cost for that process. In one embodiment, the rates in row 3403 are rates for both process operation and process setup. However, in other embodiments, these rates may differ and may be stored in different locations within spreadsheet 300. The process operation and setup rate for each process may be imported from database 240 or from stored data files using import module 242. Alternatively, or additionally, the process rate values may be manually entered or altered by a user.

Process labor cost row 3405 includes data reflecting the total cost for operating each process. In one embodiment, the total labor cost stored in process labor cost row 3405 for each process is calculated by multiplying the process time value stored in process labor time row 3401 by the process rate stored in process labor rate row 3403. For example, cell 3415 includes data reflecting a total process labor cost of $7.00 (e.g., 10.5 total minutes multiplied by an hourly rate of $40 per hour). Process setup cost row 3404 includes data reflecting the total setup cost for each process. In one embodiment, the setup cost stored in process setup cost row 3404 for each process is calculated by multiplying the process setup time value stored in setup time row 3402 by the rate value stored in process rate row 3403.

Total unit cost row 3406 includes data reflecting the total cost for the combined setup and operation of each process. For example, the total “assembly” cost of $73.67 in cell 3416 is calculated by adding the total “assembly” labor cost stored in process labor cost row 3405 (e.g., $7.00), divided by the lot size stored in cell 3014 (e.g., 1), to the total setup cost for “assembly” (e.g., $66.67) stored in process setup cost row 3404.

PF&D row 3407 includes additional data reflecting a “personal fatigue and delay” percentage associated with each process. This value indicates an expected inefficiency of the process, based on expected time deficiencies resulting from employee or other inefficiencies. The PF&D value may reflect one or more personal fatigue values associated with, for example, employee fatigue, and/or may reflect one or more other values associated with process delays. For example, a value of 10% may represent a percent decrease in productivity due to employee fatigue. Alternatively, or additionally, a value of 10% may reflect a percent delay due to process inefficiencies. The values in PF&D row 3407 may be used as a weighting coefficient for adjusting overall time values stored in process labor time row 3401 before calculating a labor process cost. Thus, a value of 10% may indicate that stored time values should be increased by 10% to account for inefficiencies associated with the process. Alternatively, the values stored in PF&D row 3407 may serve as mere indicators of expected inefficiencies during the manufacturing process. The PF&D values may be imported from database 240 or from stored data files using import module 242. Alternatively, or additionally, the PF&D values may be manually entered or altered by a user.

Accordingly, purchaser system 112 may include each of rows 3401-3407 in spreadsheet 300, to enable purchaser 110 to better understand and more easily view and alter the specific variables used to determine the should-cost price for a particular assembled good.

In one embodiment, additional data is displayed in portion 350 of spreadsheet 300, shown in FIG. 3b. Portion 350 of spreadsheet 300 shows a table that stores additional information associated with the should-cost of assembled goods. Portion 350 provides should-cost values for different categories. In one embodiment, the categories include: a total manufacturing cost, calculated by summing the values stored in the cells of process labor cost row 3405; a total material cost, calculated by summing the values stored in the cells of total material cost column 3329; a purchased item cost, calculated by summing the values stored in the cells of extended cost column 3332; a setup cost, calculated by determining the total setup cost based on the information stored in process setup cost row 3404; and a total unit cost, calculated by adding the total manufacturing cost, total material cost, total purchased item cost, and total setup cost. In one embodiment, portion 350 of spreadsheet 300 includes a profit margin cost for each of the above categories. The profit margin costs reflect the desired or expected profit margin stored in cell 3020. As shown in portion 350 of spreadsheet 300, the total costs and profit margin costs may be stored in different columns of a table. The table may store additional total values, such as a total labor time per assembled good (cell 3501), total material weight per assembled good (cells 3502), and total setup time per assembled good (cell 3503). Furthermore, the table includes a total should-cost cell (3504), which displays the total overall should-cost price (e.g., $953.17) for an assembled good. In one embodiment, this total value accounts for setup time costs, processing costs, material costs, and purchased items costs, as described above.

Spreadsheet 300 may include additional buttons 301-308 that perform preset functions when selected. As discussed previously, load data button 301, when selected, permits a user to select an assembled good and load its associated should-cost data into a blank version of spreadsheet 300. This selection causes spreadsheet 300 to be populated with should-cost data (e.g., the data shown in FIGS. 3a and 3b). Clear data button 302, when selected, clears the data stored in certain cells of spreadsheet 300. For example, in one embodiment, selecting the clear data 302 button for a spreadsheet such as shown in FIGS. 3a and 3b will clear cells 3011-3018 as well as certain cells in portions 330a, 330b, 340, and 350, resulting in a spreadsheet such as shown in FIGS. 4a and 4b. In one embodiment, selecting the clear data button 302 causes only unlocked cells with either numerical data or textual data to be cleared. As such, cells that are locked or that contain formulas (e.g., cells in rows 3401, 3404, 3406, etc., columns 3327, 3328, 3329, etc., spreadsheet portion 350, and other pre-set cells) will not be cleared, although they may display a null value (e.g., may be blank) if, for example, they contain formulas that refer to cleared cells.

Save file button 303, when selected, permits a user to save the data stored in the spreadsheet. Add rows button 304, when selected, permits a user to add one or more rows to portion 330a and 330b. For example, a user may discover an additional part that must be included in an assembled good. In such a case, the user may select the add rows button 304 and one or more new rows may be added to spreadsheet 300. Delete rows button 305, when selected, permits a user to delete one or more rows from portion 330a and 330b. For example, a user may discover that one or more parts listed in portion 330a and 330b of spreadsheet 300 may no longer be necessary. In such a case, the user may select the delete rows button 305 to delete the appropriate rows from spreadsheet 300.

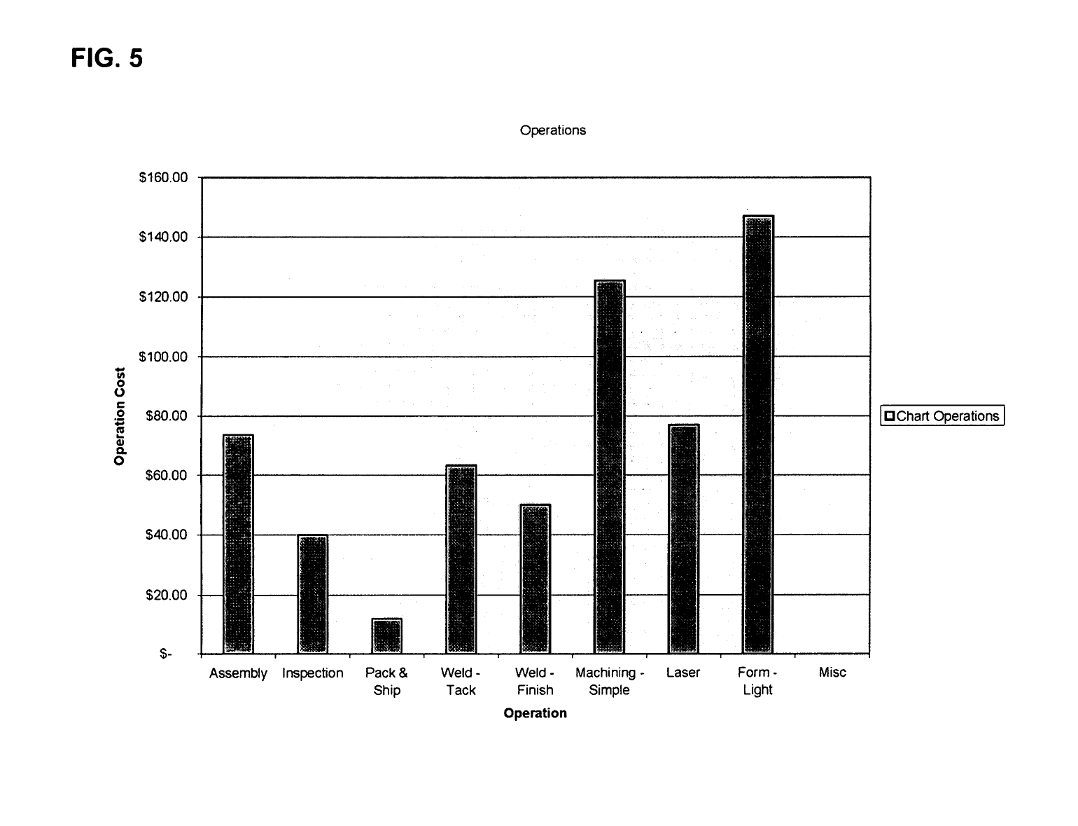

Negotiation sheet button 306, when selected, copies the entire spreadsheet and inserts it into a blank spreadsheet (e.g., into a new worksheet in Microsoft Excel), thus permitting a user to compare two versions of a should-cost spreadsheet without opening a new spreadsheet file. Chart ops button 307, when selected, creates a chart that graphically depicts the values stored in total unit cost row 3406. An example of such a chart is shown in FIG. 5. By displaying a chart, as shown in FIG. 5, a purchaser or supplier can easily determine which processes are the most expensive. Thus, using chart ops button 307 provides information that reduces resources used by a purchaser or supplier to perform mathematical comparisons of process costs. Instead, the purchaser or supplier may review the proportional differences between process costs by viewing a chart, such as that shown in FIG. 5. Rates and comments button 308, when selected, may open a pop-up window that displays one or more rates for different processes and provides a text entry portion that allows the purchaser or supplier to enter comments.

As described above, FIGS. 3a and 3b show an exemplary populated spreadsheet 300 consistent with certain disclosed embodiments. Although the data in spreadsheet 300 includes certain values, these values are given as examples only, and will vary depending on the assembled good information loaded and/or manually entered into the spreadsheet. For example, although spreadsheet 300 includes 12 part number rows and 11 process columns, the number and type of columns and rows may vary.

FIGS. 4a and 4b show an exemplary embodiment of a negotiation spreadsheet 400 before being populated with assembled good-specific information. The negotiation spreadsheet will be in this un-populated state either before any data is loaded and/or entered into the spreadsheet, or after a user selects the “clear data” button. The rows in portion 440 of spreadsheet 400 correspond to respective rows in portion 340 of spreadsheet 300, and thus contain the same type of information (and the same formulas where the cells include formulas). Similarly, the columns in portion 430b of spreadsheet 400 and the cells in portion 450 of spreadsheet 400 correspond to respective columns in portion 330b and cells in portion 350 of spreadsheet 300.

Negotiation spreadsheet 400 may be in an “unlocked” state, in which a user can view all formulas, alter all values, and use all buttons, or may be in a “locked” state, in which a user is only permitted to view and enter certain information and use certain buttons. In one embodiment, a purchaser (e.g., purchaser 110) uses spreadsheet 400 in an unlocked state, and then sends a locked negotiation spreadsheet 400 to a supplier. In one embodiment, the locked spreadsheet does not permit the supplier to use the “load data” button, and also does not permit the supplier to alter any cells in the spreadsheet that contain formulas. Other cells may be locked as well.

In one embodiment, when spreadsheet 400 is sent to a supplier, all data cells that are to contain data used to calculate the total overall should-cost of an assembled good remain unlocked. For example, in one embodiment cells 4011-4020, and cells in portion 430a, columns 4301-4316, including cells in row 4318, are unlocked to allow the user to enter part information, part quantity, process type and time, lot size, drop allowance, profit margin, etc. Furthermore, in one embodiment, cells in rows 4403 (process rates), 4407 (personal fatigue and delay percentage), and 4402 (setup time) are also unlocked to allow the user to enter process rate values, PF&D values, and setup time values. In one embodiment, the cells in row 4318 display drop-down lists when selected. These drop-down lists may include suggested names of manufacturing processes. For each cell in row 4318, a user may select any desired process (e.g., using a drop-down list), or may manually enter a process name not listed in the drop-down list.

The disclosed embodiments allow the supplier to enter information that provides an accurate estimate of a should-cost prove from the good. The information may include, for example, the name of each process, expected time for each process for each part, process rate for each process, setup time for each process, quantity of each part per assembled good, quantity of material used for each part, material cost for each part, drop allowance for each part, cost per piece of purchased items for each part, lot size, material cost, drop allowance, and profit margin, etc. Further, because the supplier is not required to select a specific process rate for each process, the supplier does not have to artificially inflate inputted time values to ensure that the total overall should-cost price is a particular value. Also, because the supplier is able to provide information for any type of process, the supplier has greater flexibility in determining a should-cost price and may organize the display of the should-cost spreadsheet as desired. In addition, by permitting the supplier to enter personal fatigue and delay values, the supplier can better convey expected inefficiencies to a purchaser, thereby better estimating an expected should-cost price.

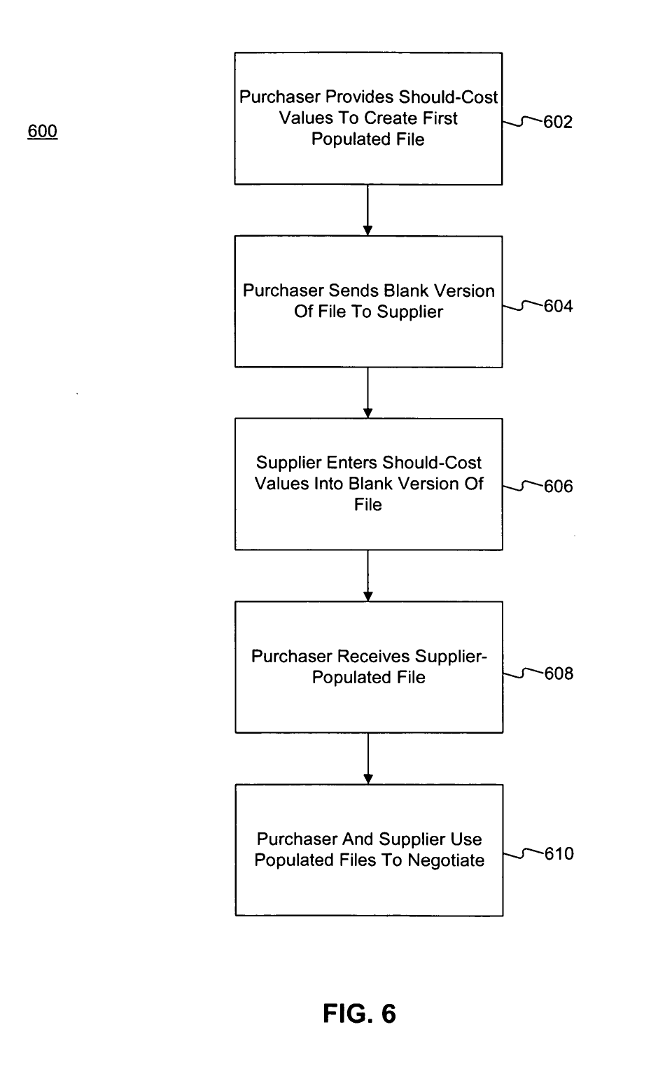

FIG. 6 shows a block diagram of an exemplary embodiment of a negotiation method that utilizes a should-cost negotiation file, such as a spreadsheet described above in connection with FIGS. 3a, 3b, 4a, and 4b. In step 602, a purchaser provides should-cost values to a first file to create a first populated file. The values may be provided to the first file by a single selection process (e.g., by selecting an assembled good from a displayed list after clicking on a load button), and/or by one or more manual entries (e.g., by entering values into the file). In one embodiment, the provided values include part numbers, operation (i.e., process) names, time entries for each operation and part number, operation rate information (e.g., dollars per hour), setup time entries for each operation, material cost for each part, and other information (e.g., information such as shown in FIGS. 3a and 3b). Based on the entered information, the file automatically populates certain data structures (e.g., cells) that include one or more formulas or logical expressions that refer to the entered information (e.g., rows 3404, 3405, etc., as described above in connection with FIGS. 3a and 3b). In one embodiment, one of these data structures is a total overall should-cost price cell that displays the total overall should-cost price of the assembled good.

In step 604, the purchaser sends a blank version of the first file to a seller of the assembled good (e.g., a supplier). The blank version may be transmitted electronically, sent by postal mail (e.g., via CD ROM or other computer-readable memory storage device), hand delivered, or sent in any other way to the seller. In one embodiment, the blank version includes locked cells and unlocked cells, such as those described previously in connection with FIGS. 3a, 3b, 4a, and 4b. In one embodiment, the blank version includes entry areas that permit the seller to enter should-cost values that include at least a cost rate value associated with performing and/or setting up an operation associated with the good, and one or more time amount values reflecting the amount of time required to set up and perform the operation on a part. By including these entry areas, the blank version of the spreadsheet permits the seller to enter accurate information regarding manufacturing costs without having to artificially inflate entered time values.

In step 606, the seller enters should-cost values into the blank version of the file. In one embodiment, the values are entered manually by the seller, and include values such as part numbers, operation (i.e., process) names, time entries for each operation and part number, operation rate information (e.g., dollars per hour), setup time entries for each operation, material cost for each part, and other information (e.g., information such as shown in FIGS. 3a and 3b). In entering values, the seller may configure the layout of a data structure representing the file. For example, the seller may manually select any set of operation columns of a spreadsheet to be displayed in any order. The seller may add rows and/or columns to the spreadsheet if necessary. In one embodiment, based on the entered information, the file may automatically populate one or more cells that include one or more formulas or logical expressions that refer to the entered information (e.g., rows 3404, 3405, etc., as described above in connection with FIGS. 3a and 3b). In one embodiment, one of these cells is a total overall should-cost price cell that displays the total overall should-cost price of the assembled good.

In step 608, the purchaser receives the seller-populated file. The file may be received electronically, by postal mail, by hand delivery, or in any other way. In one embodiment, the file may be displayed to the purchaser on a computer screen or other display device (e.g., on the seller's laptop computer). The received file may be in electronic form, paper form, or any other form that permits the purchaser to easily view the contents of the file on a single display or sheet.

In step 610, the purchaser and seller use the seller-populated file and optionally the purchaser-populated file to negotiate a sale price for the assembled good. In one embodiment, for example, the purchaser may view the seller-populated file and suggest a sale prices to the seller based on the information displayed in the file. The purchaser and seller may then orally negotiate a price. In another embodiment, both the purchaser and the seller may open electronic versions of their respective files (e.g., using a software program such as Microsoft Excel). The purchaser and seller may then discuss and/or view each others' spreadsheets and may alter the values in the files by entering data using a keyboard, mouse, or other type of input mechanism. Then once the parties agree on a sales price, information from the spreadsheet that has the agreed-upon price may be used to create a binding sales contract. Although specific negotiation examples are given, any method of negotiation may be used as would be appreciated by one skilled in the art.

### INDUSTRIAL APPLICABILITY

The disclosed should-cost negotiation methods may be used to negotiate prices between selling and purchasing parties for any type of assembled good. For example, in one embodiment, the should-cost negotiation process disclosed herein may be used by sellers and purchasers of machine equipment for vehicles used in construction, mining, paving, and other similar industries. In one embodiment, the vehicles include dozers, loaders, dump trucks, and other similar machines, and the equipment may include gas tanks, axles, engine parts, vehicle accessory parts, and other parts. However, the should-cost negotiation embodiments described herein may be used in any industry for the sale and purchase of any type of assembled goods.

In one embodiment, the seller is a manufacturer and supplier of the assembled good and the purchaser is a manufacturer that builds machines using one or more assembled goods purchased from one or more suppliers. The seller may be any supplier of the assembled good, such as a re-seller, an original equipment manufacturer (OEM), or any party that sells the assembled good and has access to should-cost information associated with the good. In addition, the seller may be an individual, a company, an agency, or any other entity or organization. The purchaser may be any individual, company, agency, or other entity or organization interested in purchasing assembled goods. In one embodiment, the data used to populate a file is taken from a bill of material stored in connection with the assembled good.

It will be apparent to those skilled in the art that various modifications and variations can be made to the should-cost negotiation embodiments disclosed herein. Other embodiments will be apparent to those skilled in the art from consideration of the specification and practice of the disclosed should-cost negotiation spreadsheet and method. It is intended that the specification and examples be considered as exemplary only, with a true scope being indicated by the following claims and their equivalents.

Further, although the disclosed embodiments include exemplary spreadsheets, it should be noted that any type of file and corresponding data structure may be used to store, process, and display the should-cost information used in the disclosed embodiments. Further, a processor that executes program code may be implemented to perform one or more of the should-cost processes disclosed herein. For example, a processor may execute software that performs one or more of the functions programmed in given cells of the disclosed should-cost spreadsheet described herein. Also, the configuration of the spreadsheet shown is not limited to that shown or described in FIGS. 3a, 3b, 4a, and 4b.

What is claimed is:

1. A method for negotiating a purchase price for an assembled good, comprising:
providing, by a purchaser, should-cost values associated with the assembled good into a first version of a first data structure, thereby creating a first file;
providing a second version of the first data structure to a seller of the assembled good, the second version of the first data structure including input portions that permit the seller to input seller should-cost values that include at least a cost rate value indicating a cost rate for performing an operation associated with the assembled good, and one or more time values indicating a time required for performing the operation on one or more parts of the assembled good;
receiving a second file from the seller, the second file including seller should-cost values provided into the second version of the first data structure by the seller; and
providing a forum for negotiating a selling price for the assembled good between the seller and purchaser based on at least the second file.

2. The method of claim 1, further including:
automatically entering the should-cost values into the first version of the first data structure, in response to a single selection by a user.

3. The method of claim 1, further including:
entering one or more of the seller should-cost values into the second version of the first data structure manually by a user.

4. The method of claim 1, further including:
providing the should-cost values into the first data structure by providing a plurality of part numbers representing a plurality of respective parts, and providing one or more time values for one or more respective operations associated with each part.

5. The method of claim 1, further including:
providing the seller should-cost values into the second version of the first data structure by:
entering a plurality of part numbers representing a plurality of respective parts;
entering one or more time values for one or more operations associated with each part; and
entering one or more cost rate values corresponding respectively to the one or more operations.

6. The method of claim 5, further including:
calculating a total operation cost for each of the one or more operations based on a total time value calculated for the operation and the cost rate value entered for the operation.

7. The method of claim 6, wherein the first data structure is a spreadsheet, and further including:
displaying the total operation cost for each of the one or more operations on a graphical display.

8. The method of claim 1, further including:
using the seller should-cost values provided by the seller to calculate a total overall should-cost price for the assembled good.

9. The method of claim 1, further including:
importing the should-cost values provided by the purchaser from one of a database and a stored text data file.

10. The method of claim 1, further including:
providing data, by the purchaser, into the first version of the data structure, the data reflecting at least one of a personal fatigue value and a delay value associated with at least one operation associated with the assembled good.

11. A method for negotiating a sale price for an assembled good, comprising:
receiving a data structure by a seller of an assembled good, the data structure file including entry areas that permit the seller to enter should-cost data;
creating a should-cost file by the seller by entering the should-cost data, by the seller, into the data structure, the should-cost data including a part identifier of one or more parts used to manufacture the assembled good, one or more operation names for one or more operations performed on the one or more parts, one or more operation time values indicating a time required for performing the one or more operations on the one or more parts, and a cost rate value indicating a cost rate for performing each of the one or more operations; and
using the should-cost file to negotiate a sale price for the assembled good between the seller and a purchaser.

12. The method of claim 11, further including:
calculating a total operation cost value for each of the one or more operations based on a total time value of the respective operation and the cost rate value of the operation; and
inputting the calculated operation cost result for each of the one or more operations into the data structure.

13. The method of claim 12, wherein the should-cost file is a spreadsheet file, and further including:
displaying the total operation cost value for each of the one or more operations on a graphical display.

14. The method of claim 11, further including:
calculating a total overall should-cost price for the assembled good based at least on the one or more operation time values and the one or more cost rate values.

15. The method of claim 11, wherein using the should-cost file to negotiate a sale price further includes:
comparing a purchaser should-cost file created using the data structure with the should-cost file created by the seller.

16. The method of claim 15, wherein negotiating the sale price further includes:
changing one or more values in the should-cost file created by the seller, and updating an overall should-cost price based on the change.

17. The method of claim 11, further including:
entering data, by the seller, into the data structure, the data reflecting at least one of a personal fatigue value and a delay value associated with at least one respective operation.

18. A computer program product stored on a computer-readable medium, the computer program product comprising:
instructions that, when executed by a processor, automatically load into a computer-readable file should-cost information including a part identifier of one or more parts used to manufacture an assembled good, one or more operation names for one or more operations performed on the one or more parts, one or more operation time values indicating a time required for performing the one or more operations on the one or more parts, and a cost rate value indicating a cost rate for each of the one or more operations;
instructions that, when executed by a processor, automatically clear data from a should-cost file;
instructions that, when executed by a processor, permit a user to manually enter should-cost values that include at least a cost rate value indicating a cost rate for performing an operation associated with the good and one or more time values indicating a time required for performing the operation on one or more parts; and
instructions that, when executed by a processor, provide the should-cost file to a seller or purchaser of the assembled good for negotiating a sale price for the assembled good.

19. The computer program product of claim 18, further including:
instructions that, when executed by a processor, automatically create a graphical representation of total operation cost values for each of one or more operations associated with manufacturing the assembled good.

20. The computer program product of claim 18, further including:
instructions that, when executed by a processor, calculate and display an overall total should-cost price derived from should-cost values stored in the should-cost file.
